(19) United States
(12) Patent Application Publication
(10) Pub. No.: US 2026/0115957 A1
(43) Pub. Date: Apr. 30, 2026

(54) HANDLING DEVICE AND METHOD FOR SEPARATING AT LEAST ONE WORKPIECE FROM A RESIDUAL GRID OF A RESIDUAL GRID ASSEMBLY OF PARTS

(71) Applicant: TRUMPF Werkzeugmaschinen SE + Co. KG, Ditzingen (DE)

(72) Inventors: Patrick Mach, Korb (DE); Stefan Krause, Wilthen (DE)

(21) Appl. No.: 19/430,373

(22) Filed: Dec. 23, 2025

Related U.S. Application Data
(63) Continuation of application No. PCT/EP2024/068418, filed on Jun. 30, 2024.

(30) Foreign Application Priority Data
Jun. 30, 2023 (DE) 102023117370.7

(51) Int. Cl. B26D 7/18; B23K 26/70

(52) U.S. Cl. CPC B26D 7/18; B23K 26/702

(57) ABSTRACT

A handling device for separating a workpiece from a residual grid of an assembly of parts, which can be produced from a plate-shaped material by a cutting process, the handling device including a support framework on which a rear-engagement device is provided which has rear-engagement elements configured to moved relative to the support framework from a disengagement position into a gripping position in which the assembly of parts is engaged from behind. The handling device includes a holder arranged on the support framework and including at least one holding element, by which the assembly of parts is configured to be transferred from the gripping position into a separating position in which the assembly of parts is lifted away from the rear-engagement elements. The assembly of parts in the separating position is subjected to vibrations to separate the at least one workpiece from the residual grid.

### CROSS REFERENCE TO RELATED APPLICATIONS

This application is a continuation of International Application No. PCT/EP2024/068418 (WO 2025/003508 A1), filed on Jun. 30, 2024, and claims benefit to German Patent Application No. DE 10 2023 117 370.7, filed on Jun. 30, 2023. The aforementioned applications are hereby incorporated by reference herein.

### FIELD

The invention relates to a handling device for separating at least one workpiece from a residual grid of a residual grid assembly of parts and a method therefor.

### BACKGROUND

EP 2 662 182 B1 discloses a method and a device for removing a residual grid assembly of parts from a workpiece support in a machine tool with subsequent separation of the workpieces from a residual grid. This device comprises a support framework on which a rear-engagement device is provided, which comprises rake-like rear-engagement elements that are movable relative to the support framework. To remove the residual grid assembly of parts, the device is positioned with an open rear-engagement device for the workpiece support so that the rake-like rear-engagement elements can be positioned between support webs of the workpiece support in order to engage on an underside of the residual grid assembly of parts. The residual grid assembly of parts resting on the rear-engagement elements is then lifted away from the workpiece support. The residual grid assembly of parts is then lifted away from the holding elements so that the workpiece parts can fall out of the residual grid. In particular, for a residual grid assembly of parts in which the workpieces are completely cut free from the residual grid, the workpieces may tilt relative to the residual grid when the residual grid assembly of parts is lifted away from the workpiece support, so that the subsequent separation of the workpieces can be hindered.

From EP 3 708 524 A1, a method for removing a workpiece from a residual grid of a residual grid assembly of parts is known. The workpiece to be removed is held in place by a suction gripping device and lifted away from the residual grid. If there is any interlocking between the workpiece and the residual grid, a vibration plate is then lowered from above onto the workpiece to be removed. After the vibration plate has landed on the workpiece, a vibration element is activated to release the interlocking between the workpiece and the residual grid.

DE 10 2021 117 265 A1 discloses a device for separating a cut-out workpiece from the residual grid. The workpiece is held fixed to the residual grid by at least one web connection. The device for separating the workpiece comprises at least one gripping element, a pulling device and an impact device, wherein the gripping element is movable in the direction of the workpiece. The gripping element is designed to grip the cut-out workpiece and the pulling device is designed to apply a pulling force away from the workpiece to the gripping element in a state connected to the workpiece, wherein the impact device is aligned such that an impact element of the impact device exerts an impact force on the base body at the web connection in order to break the web connection.

From DE 10 2010 031 001 A1, a floor conveyor device is known which comprises elongated workpiece storage elements and a floor-side chassis. In order to facilitate workpiece transfer between a workpiece support and the floor conveyor device, the workpiece storage elements can be arranged in a plurality of intermediate spaces of the support elements of the workpiece support. This allows the remaining residual grid to be easily lifted away with the cut workpieces. If the workpiece storage elements are arranged above a sheet metal cutout holder, the workpieces can be pushed through the workpiece storage elements. Alternatively, a vibrating device can be provided to free the workpieces that are still connected, for example via microjoints, to the residual grid. One variant is when a lifting device provided on the floor conveyor device serves as a vibrating device for lifting and lowering the workpiece storage elements.

### SUMMARY

In an embodiment, the present disclosure provides a handling device for separating a workpiece from a residual grid of a residual grid assembly of parts, which can be produced from a plate-shaped material by a cutting process, the handling device comprising a support framework on which a rear-engagement device is provided which has rear-engagement elements that are configured to be moved relative to the support framework from a disengagement position into a gripping position in which the residual grid assembly of parts is engaged from behind. The handling device further comprises a holder arranged on the support framework and comprising at least one holding element, by which the residual grid assembly of parts is configured to be transferred from the gripping position into a separating position in which the residual grid assembly of parts is lifted away from the rear-engagement elements. The residual grid assembly of parts arranged in the separating position is configured to be subjected to vibrations from a vibration tool in order to separate the at least one workpiece from the residual grid.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a machine arrangement for laser cutting plate-shaped workpieces with a laser cutting machine and an automation unit arranged in front of it with a handling device;

FIG. 2 illustrates a schematic side view of the handling device above a workpiece support;

FIG. 3 illustrates a schematic side view of the handling device in a lowered position relative to a residual grid assembly of parts;

FIG. 4 illustrates a schematic side view of the handling device in a gripping position for the residual grid assembly of parts after lifting away from the workpiece support;

FIG. 5 illustrates a schematic side view of the handling device at a start of a separation process;

FIG. 6 illustrates a schematic side view of the handling device with workpieces separated from the residual grid;

FIG. 7 illustrates a schematic side view of the handling device during unloading of the workpieces;

FIG. 8 illustrates a schematic side view of the handling device before unloading the residual grid;

FIG. 9 illustrates a schematic side view of the handling device after unloading the residual grid;

FIG. 10 illustrates a schematic side view of the handling device according to an embodiment;

FIG. 11 illustrates a schematic side view of the handling device according to an embodiment; and

FIG. 12 illustrates a schematic view of a holding element in an opening in the residual grid.

### DETAILED DESCRIPTION

In an embodiment, the present disclosure provides a handling device and a method for separating at least one workpiece from a residual grid of a residual grid assembly of parts in order to achieve a shortening of the process time in automation.

The foregoing is achieved by a handling device comprising a support framework on which a rear-engagement device having rear-engagement elements is provided and a holding device comprising at least one holding element which transfers the residual grid assembly of parts, perpendicular to a workpiece plane, from a gripping position resting on the rear-engagement elements into a separating position in which the residual grid assembly of parts is lifted away relative to the rear-engagement elements, in which the residual grid assembly of parts arranged in the separating position relative to the support framework can be subjected to vibrations by a vibration tool and/or shaking tool in order to separate the at least one workpiece from the residual grid. This makes it possible for at least one workpiece to be separated from the residual grid in the handling device immediately after the removal of the residual grid assembly of parts from a workpiece support of a pallet or a pallet changer by the handling device. Advantageously, the vibration tool can separate at least one workpiece from the residual grid, which is held fixed to the residual grid by a web connection, in particular a microjoint or nanojoint. Thus, such a handling device not only serves to remove the residual grid assembly of parts from the workpiece support in a machine tool, but at the same time also enables the separation of at least one workpiece from the residual grid.

In order to separate the at least one workpiece from the residual grid, the vibration tool can preferably be actuated to introduce the vibrations in a pulsed manner.

It is preferably provided that the at least one holding element of the holding device engages the residual grid assembly of parts or can be positioned engagingly in an opening in the residual grid assembly of parts. This makes it possible that, after the rear-engagement elements have been moved into a gripping position, the residual grid assembly of parts can be lifted away relative to the rear-engagement elements by means of the at least one holding element. Subsequently, vibrations can be introduced into the residual grid assembly of parts by the vibration tool. Known holding devices, such as suction elements or holding magnets, cannot ensure a secure gripping function due to the vibrations they generate.

Advantageously, it is provided that the at least one holding element is rod-shaped and has a gripping hook at a free end opposite the support framework, which grips an edge of the residual grid assembly of parts or engages in at least one opening, in particular a residual grid, and can be positioned relative to this, for example by a rotation, in a secured receiving position with respect to the residual grid assembly of parts.

Advantageously, it is provided that, after positioning the residual grid assembly of parts in the separating position, the residual grid assembly of parts is brought into contact with the vibration tool. The vibration tool can then be activated to generate the vibrations and transfer them to the residual grid assembly of parts. It is preferably provided that the vibration tool couples the vibrations into the residual grid of the residual grid assembly of parts. This can be done in a surface of the residual grid that is aligned parallel to the workpiece plane. The vibrations can also be coupled to one end face of the residual grid or to one circumferential edge of the residual grid.

The vibration tool can preferably be arranged on the support framework. After positioning the residual grid assembly in the separating position, the vibration tool can be moved towards the residual grid assembly of parts so that it rests against or on the residual grid assembly of parts. It can also be provided that, after the transfer of the residual grid assembly of parts into the separating position, the residual grid assembly of parts rests directly against the vibration tool.

The vibration tool can have one or a plurality of vibrating heads which are in direct contact with the residual grid assembly of parts, in particular the residual grid.

Alternatively, a vibration piston actuator can also be used as a vibration tool. Furthermore, it can be provided alternatively that vibrations are introduced using an impact driver technique. This is done in particular via the circumferential edge of the residual grid assembly of parts or one end face of the residual grid. This impact driver technique is preferably used for so-called thin sheets with a thickness of up to approx. 3 mm.

Furthermore, it can alternatively be provided that the vibration tool comprises a holding-down element which advantageously extends parallel to the residual grid assembly of parts in the separating position. In such an embodiment of the vibration tool with the holding-down element, workpieces can be released from the residual grid of the residual grid assembly of parts, which workpieces are either completely cut free from the residual grid or are fixed to the residual grid with an interlocking connection, in particular a microjoint or nanojoint. In particular, the holding-down element is positioned in the separating position so that the holding-down element rests against an upper side of the residual grid assembly of parts. This has the advantage that at least one workpiece, which is released from the residual grid by the vibrations, can be separated only downwards in a targeted manner.

It is preferably provided that the holding-down element is designed as a holding-down plate. In particular, the holding-down element extends over its entire surface, wherein the format of the holding-down element is equal to or larger than the format of the residual grid assembly of parts. This makes it possible for the holding-down element to be arranged in the separating position over its entire surface and, in particular, completely resting on the residual grid assembly of parts. The format refers to the flat extent, i.e., the length and width of the residual grid assembly of parts.

Advantages of the present disclosure are further achieved by a method for separating at least one workpiece from a residual grid of a residual grid assembly of parts with a handling device, in particular according to one of the previously described embodiments, in which a residual grid assembly of parts, which is held in a gripping position by rear-engagement elements, is transferred with at least one holding element of a holding device into a separating position in which the residual grid assembly of parts is lifted away relative to the rear-engagement elements and in which the residual grid assembly of parts transferred into the separating position is subjected to vibrations by a vibration tool arranged on the support framework. This makes it possible for at least one workpiece to be separated from the residual grid in the handling device. Thus, this handling device can be used not only for removing the residual grid assembly of parts from a workpiece support of a pallet or a pallet changer, but subsequently also for separating at least one workpiece from the residual grid.

Advantageously, the residual grid assembly of parts is lifted from the gripping position resting on the rear-engagement elements by the at least one holding element of the holding device to a height in a separating position which corresponds to at least 1.5 times the thickness of the residual grid assembly of parts. For example, at least one workpiece can be separated downwards from the residual grid and deposited on the rear-engagement elements, which are arranged in a gripping position, with a safety distance from the underside of the residual grid.

Furthermore, it is preferably provided that the vibration tool is placed on or brought into contact with the residual grid assembly of parts after the positioning of the residual grid assembly of parts in the separating position and/or is positioned so as to act on an end face. This allows the vibrations to be introduced into the residual grid assembly of parts both from above onto a flat extent plane and/or into a circumferential edge or end face of the residual grid assembly of parts.

Furthermore, it is preferably provided that during the cutting process of the plate-shaped material for producing at least one workpiece, openings are made in the residual grid, so that the at least one holding element of the holding device engages in the opening in the residual grid and the residual grid is transferred and held in the separating position by the at least one holding element. This has the advantage that the holding device enables the residual grid assembly of parts to be held securely, regardless of the strength of the vibrations that are coupled into the residual grid assembly of parts by the vibration tool.

Furthermore, it is preferably provided that a holding-down element is arranged on the support framework, which is positioned resting on the residual grid assembly of parts when the residual grid assembly of parts is transferred into the separating position. Opposite the residual grid assembly of parts, the vibration tool can introduce the vibrations into the holding-down element so that the vibrations are transferred to the residual grid assembly of parts via the holding-down element. This has the advantage that at least one workpiece is separated from the residual grid exclusively downwards in a targeted manner.

The holding-down element is preferably releasably and/or replaceably received by the holding element on the support framework. This also enables replacement, for example, to allow adaptation to different formats of the residual grid assembly of parts.

An embodiment of the method for separating the at least one workpiece from the residual grid provides that during the separating process the rear-engagement elements remain positioned below the residual grid assembly of parts in the gripping position and are held and received by the rear-engagement elements. The residual grid advantageously remains held to the supporting frame by at least one holding element of the holding device. The separated workpieces can then be transported and deposited by means of the handling device onto a conveyor belt or another storage location. The remaining residual grid can then be deposited separately in an unloading station or similar.

According to an embodiment of the method, it is provided that, before the start of the separating process, the handling device is positioned above a conveyor belt and the rear-engagement elements are moved into a disengagement position, so that the at least one workpiece which is removed from the residual grid during the separating process is transferred directly onto a conveyor belt. The remaining residual grid remains held to the supporting frame by the holding elements of the holding device. After separating all workpieces from the residual grid, the residual grid can advantageously be deposited in an unloading station or a storage station in a separate work step.

Preferably, the vibration tool is operated with frequencies, in particular variable frequencies, wherein the frequencies pass through a specific frequency band. The frequency band is selected such that the natural frequency of at least one component involved in the vibrations lies within the specific frequency band. This allows for an effective response to the natural frequency variation during the cutting process caused by the removed workpieces.

Advantageous embodiments and developments of the present disclosure are described and explained in more detail below by the examples illustrated in the drawings. The features that can be derived from the description and the drawings can be used individually or in any combination together according to the present disclosure.

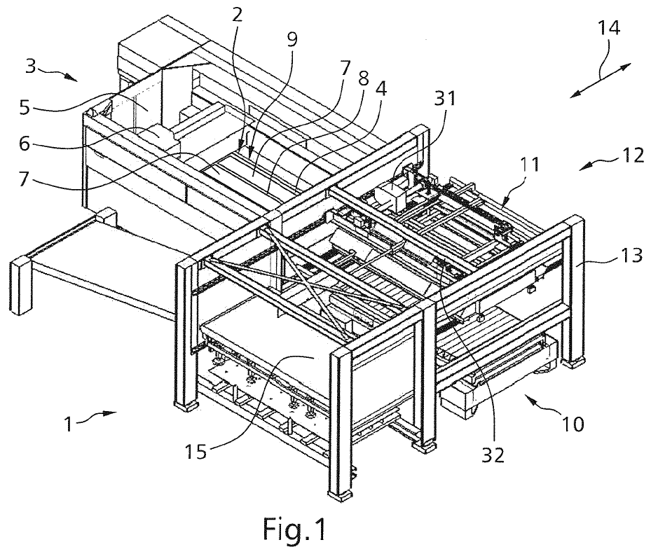

FIG. 1 shows a perspective view of a machine arrangement 1 with a machine tool 3, in which a plate-shaped material 2 is separated by a cutting device into at least one workpiece 7 and a residual grid 8 or a plurality of residual grid parts by cutting. The machine tool 3 is preferably designed as a laser cutting machine.

For the cutting process, the plate-shaped material 2, in particular the sheet metal, is arranged on a workpiece support 15 in the interior of a working area 5 of the machine tool 3. In a known manner, the plate-shaped material 2 is passed over by a laser cutting head 6 of the laser cutting machine for the cutting process. FIG. 1 shows a plate-shaped material 2 inside the working area after the cutting process, during which workpiece blanks or workpieces 7 in the form of finished parts and a residual grid 8 at least partially surrounding the workpiece 7 have been produced as processing products. There is a cutting gap of a few millimeters wide between the workpiece 7 and the residual grid 8. The at least one cut workpiece 7 and the residual grid 8 form a residual grid assembly of parts 9. It is preferably provided that the at least one workpiece 7 is completely cut free from the residual grid 8. Alternatively, it can also be provided that the workpiece 7 is connected and held in the residual grid 8 by at least one web section, in particular a microjoint or nanojoint.

The workpiece support 15 is provided on a movable pallet 4, which has been moved with the plate-shaped material 2 through a slot-shaped opening in a housing of the machine tool 3 into its working area 5. Previously, the workpiece support 15 with the unmachined plate-shaped material 2 was deposited on the end face of the machine tool 3 on a conventional pallet changer 10. On the pallet changer 10, the pallet 4 with the workpiece support 15 is moved back after the processing of the plate-shaped material 2 with the residual grid assembly of parts 9 resting thereon. The residual grid assembly of parts 9 is jointly removed from the pallet changer 10 by means of a handling device 11 of an automation unit 12.

The handling device 11 is motor-driven and can be moved on a linear device 13 of the automation unit 12 in the direction of a double arrow 14. The handling device 11 can be moved either via the pallet changer 10 or via a workpiece support 15 arranged laterally next to the pallet changer 10. In addition, in the example shown, the handling device 11 can approach a pallet 4 on which unprocessed plate-shaped material 2 is stored.

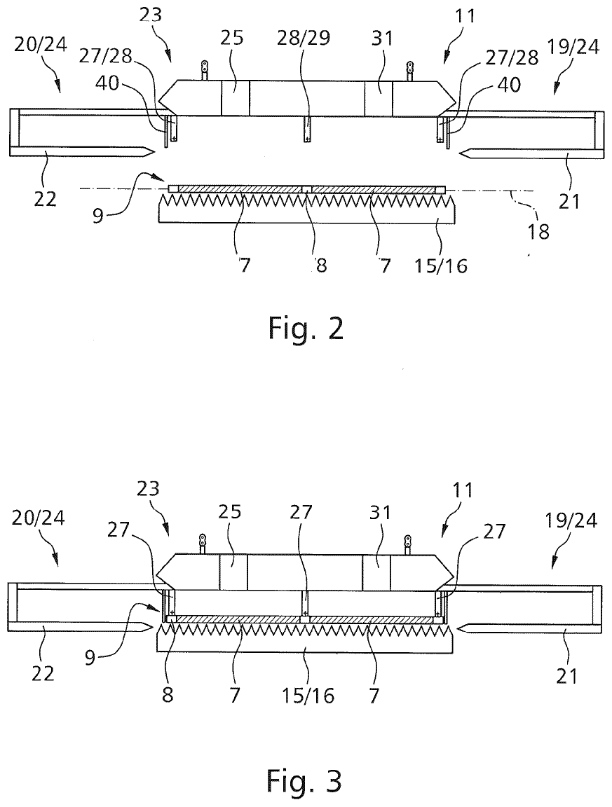

In FIG. 1, the pallet 4 with the residual grid assembly of parts 9 is still located inside the working area 5 of the machine tool 3. After the transfer of the pallet 4 and the remaining residual grid assembly of parts 9 resting thereon onto the pallet changer 10, the conditions shown schematically in FIG. 2 are obtained.

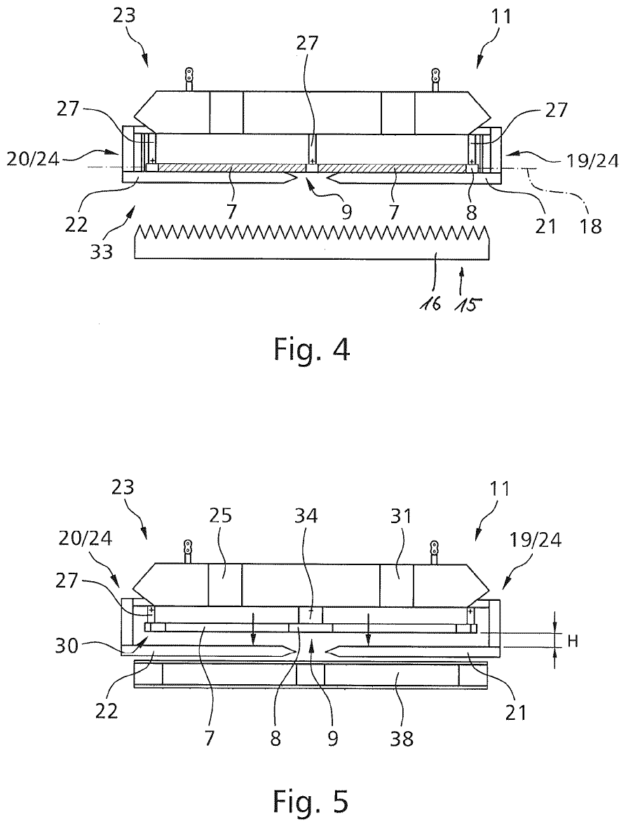

FIG. 2 shows a schematic side view of the workpiece support 15. This workpiece support 15 comprises or consists of a plurality of support webs 16 arranged one behind the other. These support webs 16 are advantageously aligned parallel to each other at a predetermined distance from each other. The residual grid assembly of parts 9 is mounted on tips of the support webs 16. This is shown schematically in a further side view according to FIG. 3. The at least one workpiece 7 and the residual grid 8 of the residual grid assembly of parts 9 rest in a horizontal workpiece plane 18, which is indicated by dash-dotted lines in FIGS. 2 and 4.

The handling device 11 is moved to a position above the pallet changer 10 or the pallet 4. Rear-engagement elements 19, 20 are arranged to be movable on a support framework 23 of the handling device 11. These rear-engagement elements 19, 20 are preferably designed in the form of a rake and have rake prongs 21, 22 arranged one behind the other with spaces perpendicular to the plane of the drawing in FIG. 2. The rear-engagement elements 19, 20 are positioned in an open position or a disengagement position relative to the support framework 23 according to FIG. 2. Together, the rake-like rear-engagement elements 19, 20 form a rear-engagement device 24 of the handling device 11. A schematically illustrated rake drive 25 on the support framework 23 serves to move the rake-like rear-engagement elements 19, 20.

The handling device 11 in the entirety shown in FIG. 2 can be moved up and down or displaced in the vertical direction relative to the pallet changer 10 or to the pallet 4 by means of a drive motor 31 shown in FIG. 1. In FIG. 1, a chassis 32 of the handling device 11 can also be seen, which supports the support framework 23 with its attachments in a vertically adjustable manner and which in turn can be moved by a motor on the linear unit 13 of the automation unit 12.

To remove the residual grid assembly of parts 9, the handling device 11 with the rear-engagement elements 19, 20 opened is lowered into the position shown in FIG. 3.

The rear-engagement elements 19, 20 are positioned at a level slightly below the underside of the residual grid assembly of parts 9.

Starting from the position of the handling device 11 shown in FIG. 3, the rear-engagement elements 19, 20 are moved against each other by means of the rake drive 25 and transferred into a gripping position 33. In the gripping position 33 of the rear-engagement elements 19, 20, the residual grid assembly of parts 9 is positioned resting on the rake prongs 21, 22.

Subsequently, the handling device 11 is moved upwards by means of the lifting drive motor 31. In a first lifting phase, the rear-engagement elements 19, 20 engage on an underside of the residual grid assembly of parts 9. This is illustrated in FIG. 4. The residual grid assembly of parts 9 rests on the rake prongs 21, 22.

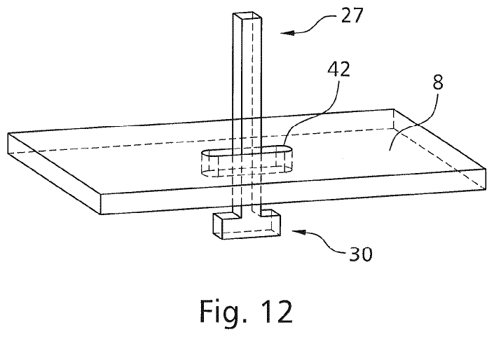

A drive 29 is provided on the support framework 23 of the handling device 11. This drive 29 is connected to holding elements 27 of the holding device 28. These holding elements 27 are known, for example, from DE 10 2012 207 867 B3, to which reference is made in full. These holding elements 27 have a gripping hook 30 at the lower end. This gripping hook 30 is inserted into an opening 42 in the residual grid 8. This at least one opening 42 can be introduced during the cutting process for separating the workpiece 7 from the residual grid 8. Subsequently, the holding element 27 is rotated and/or moved so that the gripping hook 30 engages behind the opening 42 in the residual grid 8. The holding element 27 of the holding device 28 is shown in a position in the opening 42 in the residual grid 8 in FIG. 12.

The engagement of the holding elements 27 in the residual grid 8 can take place during the downwards movement of the handling device 11 onto the residual grid assembly of parts 9, as shown in FIG. 3. After the gripping position 33 has been assumed by the rear-engagement elements 19, 20, engagement of the holding elements 27 into the opening of the residual grid 8 can also be controlled. FIG. 5 shows a schematic side view of the handling device 11 before the start of a separation process for the at least one workpiece 7 from the residual grid 8 of the residual grid assembly of parts 9. The residual grid assembly of parts 9 has been lifted from the gripping position 33, in which the residual grid assembly of parts rests on the rear-engagement elements 19, 20, into a separating position 35. The drive 29 moves the holding elements 27 of the holding device 28 upwards relative to the supporting frame 23. In this case, a travel path is preferably provided which corresponds to a height H of at least 1.0 times, in particular 1.5 times, the thickness of the residual grid assembly of parts 9. This makes it possible for the workpiece 7 to rest securely on the rear-engagement elements after it has been separated from the residual grid 8 and, on the other hand, for a safety distance to remain from the underside of the residual grid.

The handling device 11 comprises a vibration tool 34. This vibration tool 34 can be arranged on the support framework 23 or connected thereto. The vibration tool 34 can be fixedly positioned on the support framework 23. The vibration tool 34 can also be designed to be movable relative to the support framework 23 using a drive. Thus, for example, if the material of the residual grid assembly of parts 9 is different, a corresponding travel movement can be controlled so that, for example, the vibration tool rests on an upper side of the residual grid assembly of parts 9. The vibration tool can also be moved, for example, parallel to the upper side of the residual grid assembly of parts 9. Such a travel movement can be controlled in particular when the vibration tool 34 introduces the vibrations into the residual grid of the residual grid assembly of parts 9 and not into the workpiece 7.

The vibration tool 34 can generate vibrations or a shaking movement and transmit them to the residual grid assembly of parts 9. A pulsed introduction of the vibrations can be advantageous. As a result, a cut-out workpiece 7, which is glued or clamped in the residual grid 8, can be separated from the residual grid. Furthermore, it can also be provided that the at least one workpiece 7, which is connected to the residual grid 8 by an interlocking connection, in particular by a microjoint or nanojoint, is separated from the residual grid 8. The vibration excitation and/or shaking movement breaks the interlocking connection so that at least one workpiece 7 is separated from the residual grid 8.

The separation process in the handling device 11 can advantageously be monitored by at least one sensor or one camera. For example, after all workpieces 7 have been separated from the residual grid 8 and these have advantageously been detected by at least one sensor, the separation process can be terminated. The vibration tool 34 is stopped.

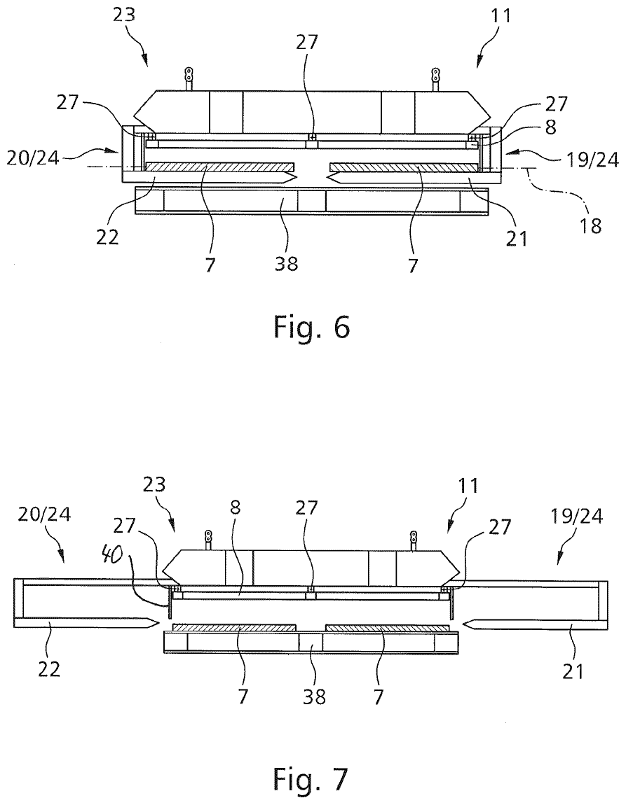

Due to the gravity of the workpiece 7, it is separated downwards relative to the residual grid 8 and then rests on the rear-engagement elements 19, 20. This is illustrated in FIG. 6.

Starting from the position of the handling device 11 shown in FIG. 6 above a storage pallet 38, the separated workpieces 7 can then be unloaded. The rear-engagement elements 19, 20 are moved from the gripping position 33 into a disengagement position. By means of the strippers 40 arranged on the support framework 23, the workpieces 7 are held above the storage pallet 38 during the movement of the rear-engagement elements 19, 20 and can then be deposited on the storage pallet 38. This is illustrated in FIG. 7.

Alternatively, the handling device 11 can also be positioned above a conveyor belt. The unloading of the workpieces 7 takes place analogously to that described above for FIGS. 6 and 7. The workpieces 7 are then deposited on a conveyor belt and transported away. These can then be fed to another processing station. Alternatively, these can also be transferred to a storage bin or storage facility.

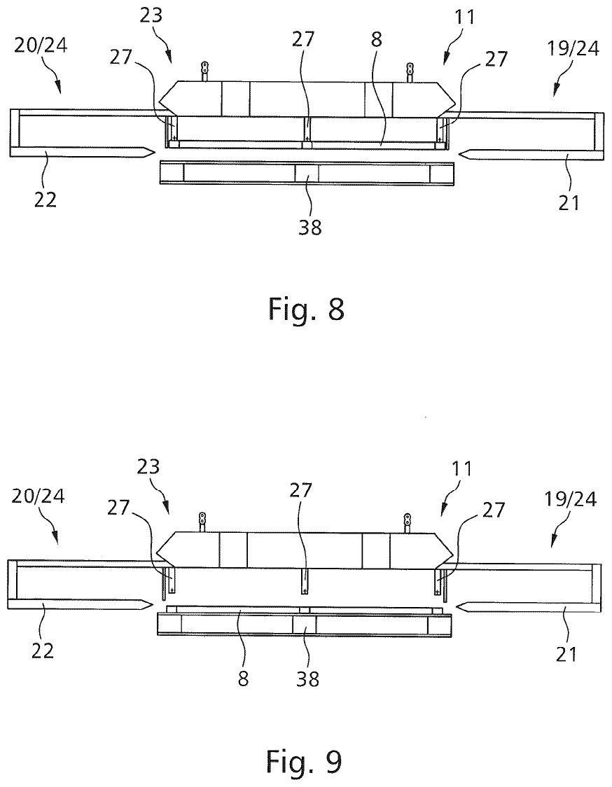

In a subsequent work step, the residual grid 8 is removed from the handling device 11. FIG. 8 shows a position of the handling device 11 above another storage pallet 38. The holding elements 27 are lowered from the separating position 35 relative to the support framework 23. Subsequently, the holding elements 27 are controlled with a release strategy so that the gripping hooks 30 are released from the openings in the residual grid 8 and the residual grid 8 is deposited lying on the further storage pallet 38. This is shown in FIG. 9.

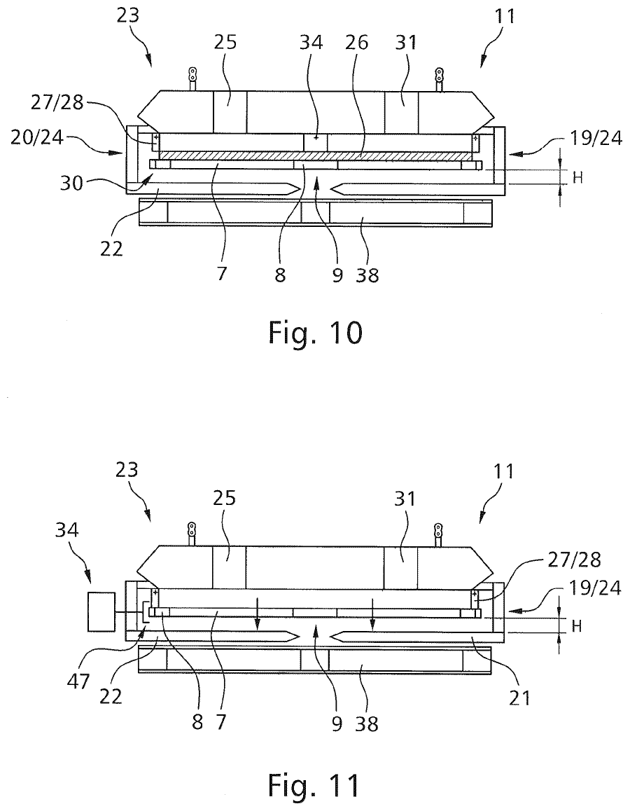

FIG. 10 illustrates a schematic side view of an alternative embodiment of the handling device in relation to FIG. 5. In this embodiment, it is provided that the vibration tool 34 comprises a holding-down element 26. The holding-down element 26 can be arranged interchangeably on other holding elements. This allows different sizes or flat formats of the holding-down element 26 to be used. The holding-down element 26 is preferably designed as a holding-down plate. This holding-down element 26 is advantageously designed to have a full surface, so that a flat surface extends completely over the entire format. An underside of the holding-down element 26 is preferably provided in the separating position 35. After the transfer of the residual grid assembly of parts 9 from the gripping position 33 into the separating position 35, the residual grid assembly of parts 9 rests with an upper side on the underside of the holding-down element 26. The vibration tool 34 is positioned on the upper side of the holding-down element 26. After the residual grid assembly of parts 9 is positioned adjacent to the holding-down element 26 in the separating position 35, the vibration tool 34 is switched on and the generated vibrations are introduced into the holding-down element 26. The vibrations spread within the holding-down element 26. As a result, vibrations are transmitted across the entire underside of the holding-down element 26 to the upper side of the residual grid assembly of parts 9. This has the advantage that the entire residual grid assembly of parts 9 is subjected to vibrations for separating at least one workpiece 7 from the residual grid 8.

In FIG. 10, the vibration tool 34 is shown merely as a single exemplary element. It is understood that a plurality of vibration tools 34 can be assigned to the holding-down element 26 at different positions. It is also provided for a vibration tool to be positioned on one end face of the circumferential edge of the holding-down element 26.

FIG. 11 illustrates a schematic side view of an alternative embodiment of the handling device 11 in relation to FIG. 5. Before the separation process begins, the residual grid assembly of parts 9 is lifted into the separating position 35. The rear-engagement elements 19, 20 can remain in the gripping position 33 or can also be transferred to a disengagement position, provided that the handling device 11 is positioned above a conveyor belt or a storage pallet.

This handling device 11 comprises a vibration tool 34 which uses an impact driver technique. For example, a U-shaped or fork-shaped impact element 47 can be provided, which can be positioned to engage an end face of the residual grid assembly of parts 9. By means of a successive back-and-forth rotational movement of the impact element 47, a shaking movement can be initiated into the residual grid assembly of parts 9 in order to separate out at least one workpiece 7. Particularly in the case of thin sheets, the impact element 47 can act on an end face of the residual grid assembly of parts 9.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A handling device for separating a workpiece from a residual grid of a residual grid assembly of parts, which can be produced from a plate-shaped material by a cutting process, the handling device comprising:
a support framework on which a rear-engagement device is provided which has rear-engagement elements that are configured to be moved relative to the support framework from a disengagement position into a gripping position in which the residual grid assembly of parts is engaged from behind; and
a holder arranged on the support framework and comprising at least one holding element, by which the residual grid assembly of parts is configured to be transferred from the gripping position into a separating position in which the residual grid assembly of parts is lifted away from the rear-engagement elements,
wherein the residual grid assembly of parts arranged in the separating position is configured to be subjected to vibrations from a vibration tool in order to separate the at least one workpiece from the residual grid.

2. The handling device according to claim 1, wherein the vibrations of the vibration tool are configured to be controlled in pulses.

3. The handling device according to claim 1, wherein, after positioning the residual grid assembly of parts in the separating position, the residual grid assembly of parts is configured to be brought into contact with the vibration tool.

4. The handling device according to claim 1, wherein the vibration tool has one or more vibration heads or at least one vibration piston actuator, which is configured to be in direct contact with the residual grid of the residual grid assembly of parts.

5. The handling device according to claim 1, wherein the vibration tool is configured as an impact driver, by which the vibrations are configured to be introduced into a circumferential edge of the residual grid assembly of parts.

6. The handling device according to claim 1, wherein the vibration tool comprises a holding-down element, which extends parallel to the separating position, and wherein the residual grid assembly of parts is configured to be positioned in the separating position so as to rest on the holding-down element.

7. The handling device according to claim 6, wherein the holding-down element extends over its entire surface.

8. A method for separating at least one workpiece from a residual grid of a residual grid assembly of parts, which can be produced from a plate-shaped material by a cutting process, the method comprising:
moving, on a support framework, a rear-engagement device with rear-engagement elements relative to a support framework of the handling device between a disengagement position and a gripping position, in which the residual grid assembly of parts is engaged from behind;
transferring, by a holder arranged on the support framework and including at least one holding element, the residual grid assembly of parts from the gripping position into a separating position in which the residual grid assembly of parts is lifted away from the rear-engagement elements; and
subjecting the residual grid assembly of parts arranged in the separating position to vibrations from a vibration tool to separate the at least one workpiece from the residual grid.

9. The method according to claim 8, wherein the residual grid assembly of parts is lifted away from the gripping position relative to the rear-engagement elements to a height for assuming the separating position which corresponds to at least 1 times a thickness of the residual grid assembly of parts.

10. The method according to claim 8, wherein the vibration tool is placed on an upper side of the residual grid assembly of parts and/or positioned on an end face of the residual grid assembly of parts after positioning of the residual grid assembly of parts in the separating position.

11. The method according to claim 8, wherein, during the cutting process of the plate-shaped material for producing the at least one workpiece, at least one opening is introduced into the residual grid, wherein at least one rod-shaped holding element having a gripping hook provided at an end opposite the support framework is inserted into the at least one opening in the residual grid, and wherein subsequently the residual grid assembly of parts is lifted into the separating position.

12. The method according to claim 8, wherein the vibration tool comprises a holding-down element, which is received by the support framework, and wherein, when the residual grid assembly of parts is transferred into the separating position, the holding-down element is positioned to rest on the residual grid assembly of parts.

13. The method according to claim 8, wherein, during a separating process in which the residual grid assembly of parts is subjected to vibrations, the rear-engagement elements remain positioned below the residual grid assembly of parts in the gripping position and the at least one workpiece separated from the residual grid is held in place by the rear-engagement elements.

14. The method according to claim 8, wherein, before a start of a separation process in which the residual grid assembly of parts is subjected to vibrations, the handling device is positioned above a conveyor belt and the rear-engagement elements are moved into a disengagement position, so that the at least one workpiece separated from the residual grid is transferred to the conveyor belt.

15. The method according to claim 13, wherein, after the at least one workpiece has been separated from the residual grid, the residual grid is deposited in an unloading station or a storage station in a separate work step.

16. The method according to claim 8, wherein the vibration tool is operated at frequencies which pass through a specific frequency band, wherein a natural frequency of the at least one component excited to vibrate lies within the frequency band.

17. The handling device according to claim 7, wherein a format of the holding-down element is equal to or larger than a format of the residual grid assembly of parts.

18. The method according to claim 9, wherein the residual grid assembly of parts is lifted away from the gripping position relative to the rear-engagement elements to a height for assuming the separating position which corresponds to at least 1.5 times the thickness of the residual grid assembly of parts.

19. The method according to claim 10, wherein the vibration tool is positioned on the support framework.

20. The method according to claim 12, wherein the holding-down element is releasably and/or replaceably received by further holding elements on the support framework.
